(19) United States
(12) Patent Application Publication
(10) Pub. No.: US 2026/0071632 A1
(43) Pub. Date: Mar. 12, 2026

(54) SINGLE-SHAFT UNITARY CENTRIFUGAL ROTOR FOR AN AIR CYCLE MACHINE

(71) Applicant: Hamilton Sundstrand Corporation, Charlotte, NC (US)

(72) Inventors: Jeremy Clavette, Farmington, CT (US); Zachary Alex Schuster, Milwaukee, WI (US); Viktor Kilchyk, Williamsville, NY (US); John Giuliano, North Granby, CT (US)

(21) Appl. No.: 18/828,343

(22) Filed: Sep. 9, 2024

(51) Int. Cl. F04D 29/28; B33Y 80/00; F04D 29/056

(52) U.S. Cl. CPC F04D 29/284; F04D 29/056; B33Y 80/00

(57) ABSTRACT

A single-shaft unitary centrifugal rotor for an air cycle machine (ACM), having: a body extending from a body forward end to a body aft end; a flange intermediate the body forward and aft ends; a first rotor extending forward from the flange by a first axial length to a first rotor end at or near the body forward end, the first rotor defining a first hub and a first blade stage extending outwardly from the first hub; a second rotor extending aft from the flange by a second axial length to a second rotor end at or near the body aft end, and defining a second hub and a second blade stage extending outwardly from the second hub; a passage defined through the unitary rotor, between the body forward and aft ends, that receives a drive shaft.

### BACKGROUND

The embodiments are directed to an air cycle machine (ACM) and more specifically to a single shaft, unitary centrifugal rotor for an ACM.

An ACM may contain several separate rotors throughout an axial length of the ACM. Each rotor may correspond to a specific stage within the ACM. Utilizing separate components for the different stages can impact the efficiency, size and weight of the ACM.

### BRIEF SUMMARY

Disclosed is a single-shaft unitary centrifugal rotor for an air cycle machine (ACM), including: a body extending from a body forward end to a body aft end; a flange intermediate the body forward and aft ends; a first rotor extending forward from the flange by a first axial length to a first rotor end at or near the body forward end, the first rotor defining a first hub and a first blade stage extending outwardly from the first hub; a second rotor extending aft from the flange by a second axial length to a second rotor end at or near the body aft end, and defining a second hub and a second blade stage extending outwardly from the second hub; a passage defined through the unitary rotor, between the body forward and aft ends, that receives a drive shaft.

In addition to one or more of the above disclosed aspects of the rotor or as an alternate, the unitary rotor is additively manufactured.

In addition to one or more of the above disclosed aspects of the rotor or as an alternate, at the body forward and aft ends, the passage defines a radially stepped-out segment, to seat a journal bearing.

In addition to one or more of the above disclosed aspects of the rotor or as an alternate, a cavity is defined along the passage, intermediate the body forward and aft ends, the cavity being radially larger than the passage and seats a thrust bearing.

In addition to one or more of the above disclosed aspects of the rotor or as an alternate, the flange has a radial outer surface, and a radial channel extends radially inwardly from the radial outer surface, and thermal insulation is disposed within the radial channel.

In addition to one or more of the above disclosed aspects of the rotor or as an alternate: a first blade profile is defined by the first hub; a second blade profile is defined by a first outer edge of the first blade stage; a third blade profile is defined by the second hub; and a fourth blade profile is defined by a second outer edge of the second blade stage.

In addition to one or more of the above disclosed aspects of the rotor or as an alternate: the first blade stage defines a first flow path having a first flow area that increases towards the body forward end; and the second blade stage defines a second flow path having a second flow area that increases towards the body aft end.

In addition to one or more of the above disclosed aspects of the rotor or as an alternate: the first axial length is greater than the second axial length; and a curvature of the third and fourth blade profiles is steeper than a curvature of ones of the first and second blade profiles, whereby the first blade stage is radially longer than the second blade stage and the first flow area is larger than the second flow area.

In addition to one or more of the above disclosed aspects of the rotor or as an alternate, the rotor includes: a first shroud extending from a first shroud forward end to a first shroud aft end over the first blade stage and conforming to the second blade profile, wherein the first shroud aft end is forward of the flange, to define a first stage forward opening at the body forward end and a first stage aft opening at the flange, wherein a third blade stage extends radially outwardly from the first shroud; and a fifth blade profile is defined by a third outer edge of the third blade stage.

In addition to one or more of the above disclosed aspects of the rotor or as an alternate, the third blade stage defines a third flow path having a third flow area that increases towards the body forward end.

In addition to one or more of the above disclosed aspects of the rotor or as an alternate: the first axial length is greater than the second axial length; and a curvature of the third and fourth blade profiles is steeper than a curvature of ones of the first and second blade profiles, whereby the first blade stage is radially longer than the second blade stage and the first flow area is larger than the second flow area.

In addition to one or more of the above disclosed aspects of the rotor or as an alternate, the rotor includes: a second shroud extending from a second shroud forward end to a second shroud aft end over the second blade stage and conforming to the fourth blade profile, wherein the second shroud forward end is aft of the flange, to define a second stage forward opening at the flange and a second stage aft opening at the body aft end, wherein a fourth blade stage extends radially outwardly from the second shroud; and a sixth blade profile is defined by a fourth outer edge of the fourth blade stage.

In addition to one or more of the above disclosed aspects of the rotor or as an alternate, the fourth blade stage defines a fourth flow path having a fourth flow area that increases towards the body aft end.

In addition to one or more of the above disclosed aspects of the rotor or as an alternate, the unitary rotor is symmetrical about the flange.

Disclosed is a rotor assembly, including a rotor having one or more of the above disclosed aspects; and a shaft extending through the passage; and forward and aft journal bearings disposed on opposite ends of the shaft and configured so seat in ones of the radially stepped-out segment.

In addition to one or more of the above disclosed aspects of the rotor assembly, or as an alternate, the assembly further includes a thrust bearing at one end of the shaft, axially offset from the adjacent one of the forward and aft journal bearings.

Disclosed is another embodiment of the rotor assembly, including a rotor having one or more of the above disclosed aspects; a shaft extending through the passage; forward and aft journal bearings disposed on the unitary rotor and configured so seat in ones of the radially stepped-out segment; and the thrust bearing disposed on the unitary rotor and configured to seat in the cavity.

### BRIEF DESCRIPTION OF THE DRAWINGS

The following descriptions should not be considered limiting in any way. With reference to the accompanying drawings, like elements are numbered alike:

FIG. 1 shows an aircraft that may utilize aspects of the disclosed embodiments;

FIG. 2 shows a cross sectional view of a two stage embodiment of a unitary rotor;

FIG. 3 shows a perspective view of the two stage embodiment of the unitary rotor;

FIG. 4 shows another cross sectional view of the two stage embodiment of the unitary rotor with a drive shaft;

FIG. 5 shows a cross sectional view of a three stage embodiment of a unitary rotor;

FIG. 6 shows a perspective view of the three stage embodiment of the unitary rotor; and

FIG. 7 shows a cross sectional view of a four stage embodiment of a unitary rotor.

### DETAILED DESCRIPTION

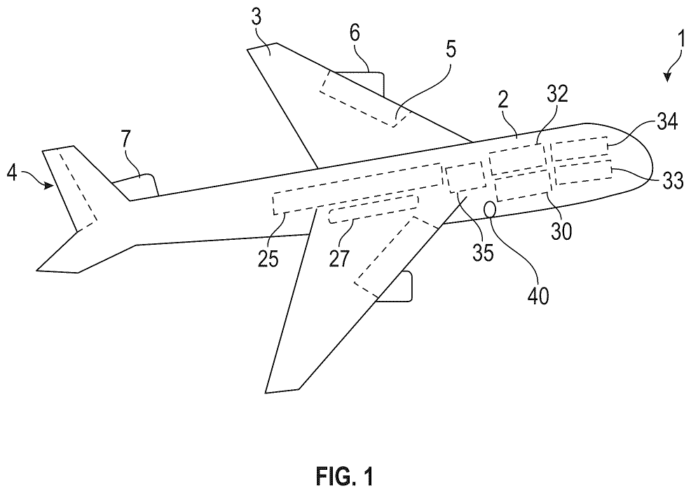

FIG. 1 shows an aircraft 1 having a fuselage 2 with a wing 3 and tail assembly 4, which may have control surfaces 5. The wing 3 may include an engine 6, such as a gas turbine engine, and an auxiliary power unit 7 may be disposed at the tail assembly 4. The aircraft 1 may have a cabin 25, a cargo bay 27, an environmental control system (ECS) 30 for conditioning the cabin 25 and/or cargo bay 27. The ECS 30 may include a vapor compression system (VCS) 32 that cools air directed to, e.g., the cargo bay 27 and provides refrigeration to one or more systems 35 of the aircraft 1, and an air cycle machine (ACM) 33 that cools air directed to e.g., the cabin 25. A RAM air inlet 40 may scoop air for the ECS 30, or the ECS 30 may receive air recirculated from, e.g., a cabin air compressor (CAC) 34.

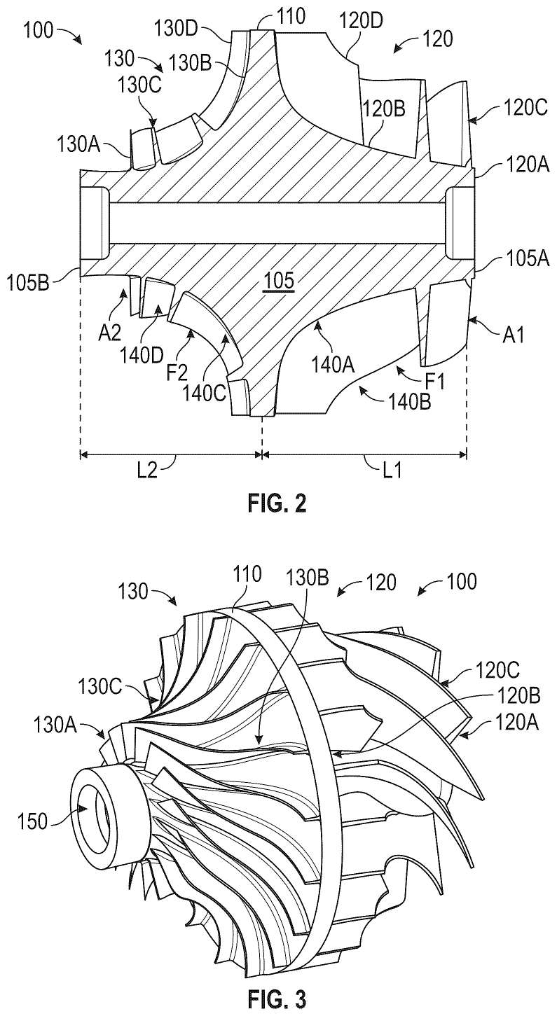

Turning to FIGS. 2 and 3, a single shaft, unitary (one-piece, monolithic) centrifugal rotor (for simplicity, a unitary rotor) 100 is shown for an ACM 33, which defines a plurality of rotors integrated into a unitary structure. The unitary rotor 100 may be additively manufactured, machined or cast. The unitary rotor 100 has a body 105 that extends from a body forward end 105A to a body aft end 105B and includes a flange 110. A first rotor 120 extends forward from the flange 110 by a first axial length L1 to a first rotor end 120A, at the body forward end 105A. The first rotor 120 defines a first hub 120B and a first blade stage 120C extending outwardly from the first hub 120B. A second rotor 130 extends aft from the flange 110 by a second axial length L2 to a second rotor end 130A, at the body aft end 105B. The second rotor 130 defines a second hub 130B and a second blade stage 130C extending outwardly from the second hub 130B.

A first blade profile 140A that may be arcuate is defined by the first hub 120B. A second blade profile 140B that may be arcuate is defined by a first outer edge 120D of the first blade stage 120C (i.e., defined along the outer edges of each of the blades of the first blade stage 120C). The first blade stage 120C defines a first flow path F1 having a first flow area A1 that increases towards the body forward end 105A. A third blade profile 140C that may be arcuate is defined by the second hub 130B. A fourth blade profile 140D that may be arcuate is defined by a second outer edge 130D of the second blade stage 130B. The second blade stage 130C defines a second flow path F2 having a second flow area A2 that increases towards the body aft end 105A. That is, both areas increase away from the flange 110.

As shown in FIG. 2, the first axial length L1 is greater than the second axial length L2, and a curvature of the third and fourth blade profiles 140C, 140D is steeper than a curvature of respective ones of the first and second blade profiles 140A, 140B. From this configuration, the first blade stage 120C is radially longer than the second blade stage 130C, and the first flow area A1 is larger than the second flow area A2. This configuration is not intended on limiting the scope of the embodiments. The configuration of the first and second blade stages 120C, 130C results in a compression of flows along each stage 120C, 130C that are directed from the outer ends 105A, 105B of the body 105 toward the flange 110. That is, flows in the opposite direction, from the flange 110 toward the outer ends 105A, 105B of the body 105 will expand. With the unitary rotor 100, either side may be used in an ACM 33 as a compressor stage or a turbine stage, depending on the flow direction. The unitary rotor in FIG. 2 is suitable for an ACM 33 requiring two stages, as a combination of compressors and turbines. In addition, the ratios of compression and expansion are different on each stage 120C, 130C of the unitary rotor 100, though that is not intended on limiting the scope of the embodiments. Further, the unitary rotor 100 is asymmetric about the flange 110, though that is not intended on limiting the scope of the disclosure.

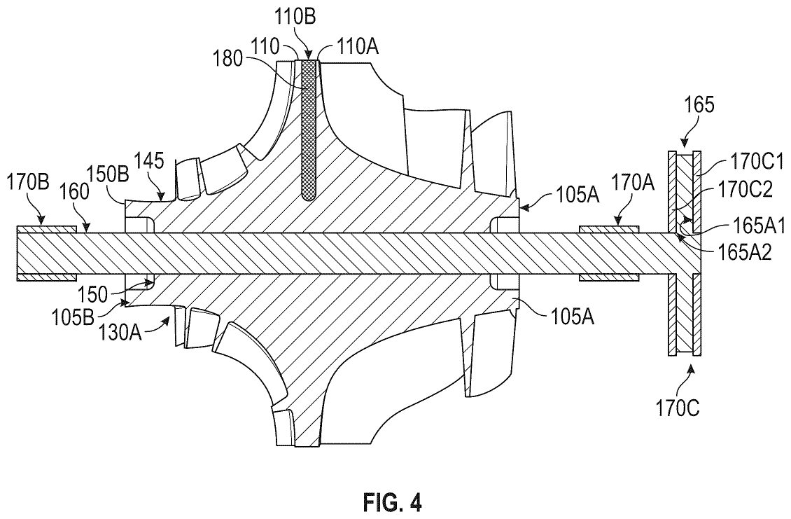

Turning to FIG. 4, a bladeless section 145 of the rotor hub may extend from either or both of the body forward and aft ends 105A, 105B, depending on configuration requirements. As shown in FIG. 4, the bladeless section 145 extends aft from the second rotor end 130A. A passage 150 is defined through the unitary rotor 100, between the body forward and aft ends 105A, 105B. The passage 150 receives a drive shaft 160. At the body forward and aft ends 105A, 105B, the passage 150 defines a radially stepped-out segment 150A, 150B, to seat journal bearings 170A, 170B on the drive shaft 160. Thrust bearings 170C1, 170C2 (generally 170C) may be on opposite sides 165A1, 165A2 of a shaft end flange 165 at an axial end of the drive shaft 160. The flange 110 has a radial outer surface 110A. A radial channel 110B may extend radially inwardly from the radial outer surface 110A. Thermal insulation 180 may be disposed within the radial channel 110B to reduce heat transference from between the rotors 120, 130.

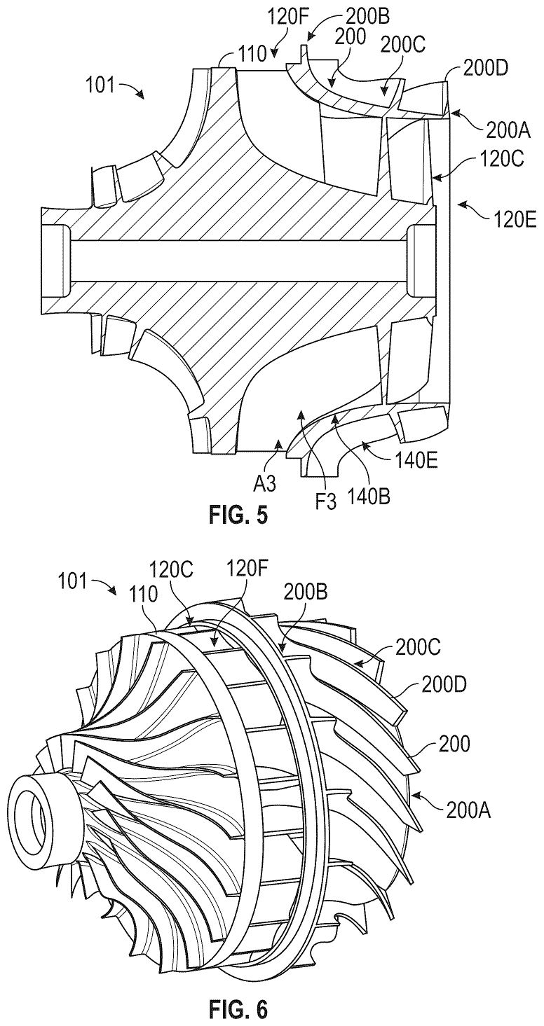

Turning to FIGS. 5 and 6, another embodiment of the single shaft, unitary (one-piece, monolithic) centrifugal rotor 101 is shown, having the same features of the embodiment shown in FIG. 2 and through 4 except as indicated.

More specifically (with reference numbers labeled in FIGS. 2 and 3), the unitary rotor 101 may be additively manufactured, machined or cast. The unitary rotor 101 has a body 105 that extends from a body forward end 105A to a body aft end 105B and includes a flange 110. A first rotor 120 extends forward from the flange 110 by a first axial length L1 to a first rotor end 120A, at the body forward end 101A. The first rotor 120 defines a first hub 120B and a first blade stage 120C extending outwardly from the first hub 120B. A second rotor 130 extends aft from the flange 110 by a second axial length L2 to a second rotor end 130A, at the body aft end 105B. The second rotor 130 defines a second hub 130B and a second blade stage 130C extending outwardly from the second hub 130B.

A first blade profile 140A that may be arcuate is defined by the first hub 120B. A second blade profile 140B that may be arcuate is defined by a first outer edge 120D of the first blade stage 120C (i.e., defined along the outer edges of each of the blades of the first blade stage 120C). The first blade stage 120C defines a first flow path F1 having a first flow area A1 that increases towards the body forward end 105A. A third blade profile 140C that may be arcuate is defined by the second hub 130B. A fourth blade profile 140D that may be arcuate is defined by a second outer edge 130D of the second blade stage 130B. The second blade stage 130C defines a second flow path F2 having a second flow area A2 that increases towards the body aft end 105A. That is, both areas increase away from the flange 110.

The first axial length L1 is greater than the second axial length L2, and a curvature of the third and fourth blade profiles 140C, 140D is steeper than a curvature of respective ones of the first and second blade profiles 140A, 140B. From this configuration, the first blade stage 120C is radially longer than the second blade stage 130C, and the first flow area A1 is larger than the second flow area A2. This configuration is not intended on limiting the scope of the embodiments.

Further regarding the second embodiment of the unitary rotor 101, (with reference numbers labeled in FIG. 4) a bladeless section 145 may extend from either or both of the body forward and aft ends 105A, 105B, depending on configuration requirements. A passage 150 is defined through the unitary rotor 101, between the body forward and aft ends 105A, 105B. The passage 150 receives a drive shaft 160. At the body forward and aft ends 105A, 105B, the passage 150 defines a radially stepped-out segment 150A, 150B, to seat journal bearings 170A, 170A on the drive shaft 160. Thrust bearings 170C may be at an axial end of the drive shaft 160 (FIG. 4). The flange 110 has a radial outer surface 110A. A radial channel 110B may extend radially inwardly from the radial outer surface 110A. Thermal insulation 180 may be disposed within the radial channel 110B to reduce heat transference from between the rotors 120, 130.

In FIGS. 5 and 6, a first shroud 200 extends from a first shroud forward end 200A to a first shroud aft end 200B over the first blade stage 120C and conforms to the second blade profile 140B. The first shroud aft end 200B is forward of the flange 110. This configuration defines a first stage forward opening 120E at the body forward end 105A and a first stage aft opening 120F at the flange 110. A third blade stage 200C extends radially outwardly from the first shroud 200. A fifth blade profile 140E that may be arcuate is defined by a third outer edge 200D of the third blade stage 200C. The curvature of the second blade profile 140B may be steeper than a curvature of the fifth blade profile 140E, or vice versa, though this is not intended on limiting the scope of the embodiment. The third blade stage 200C defines a third flow path F3 having a third flow area A3 that increases towards the body forward end 105A.

As with the embodiment of FIG. 2, the configuration of the third blade stage 200C results in a compression of flows that are directed along the stage from the body forward end 105A toward the flange 110. That is, flows in the opposite direction, from the flange 110 toward the body forward end 105A will expand. The third blade stage 200C may be used in an ACM 33 as a compressor stage or a turbine stage, depending on the flow direction. That is, the unitary rotor in FIG. 5 is suitable for an ACM 33 requiring three stages, as a combination of compressors and turbines. In addition, the ratios of compression and expansion are different on each blade stage 120C, 130C, 200C of the unitary rotor 101, though that is not intended on limiting the scope of the embodiments. Further, the unitary rotor 101 is asymmetric about the flange 110, though that is not intended on limiting the scope of the embodiments.

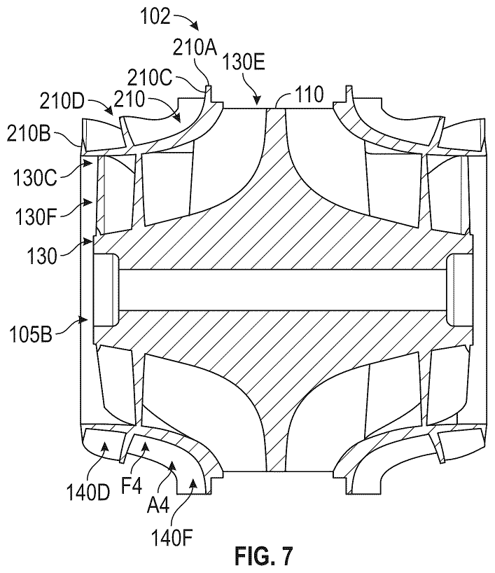

Turning to FIG. 7, a third embodiment of the single shaft, unitary (one-piece, monolithic) centrifugal rotor 102 is shown, having the same features of the embodiment shown in FIGS. 5 and 6 except as indicated.

More specifically (with reference numbers labeled in FIGS. 2 and 3), the unitary rotor 102 may be additively manufactured, machined or cast. The unitary rotor 102 has a body 105 that extends from a body forward end 105A to a body aft end 105B and includes a flange 110. A first rotor 120 extends forward from the flange 110 by a first axial length L1 to a first rotor end 120A, at the body forward end 102A. The first rotor 120 defines a first hub 120B and a first blade stage 120C extending outwardly from the first hub 120B. A second rotor 130 extends aft from the flange 110 by a second axial length L2 to a second rotor end 130A, at the body aft end 105B. The second rotor 130 defines a second hub 130B and a second blade stage 130C extending outwardly from the second hub 130B.

A first blade profile 140A that may be arcuate is defined by the first hub 120B. A second blade profile 140B that may be arcuate is defined by a first outer edge 120D of the first blade stage 120C (i.e., defined along the outer edges of each of the blades of the first blade stage 120C). The first blade stage 120C defines a first flow path F1 having a first flow area A1 that increases towards the body forward end 105A. A third blade profile 140C that may be arcuate is defined by the second hub 130B. A fourth blade profile 140D that may be arcuate is defined by a second outer edge 130D of the second blade stage 130B. The second blade stage 130C defines a second flow path F2 having a second flow area A2 that increases towards the body aft end 105A. That is, both areas increase away from the flange 110.

Further regarding the third embodiment of the unitary rotor 102, (with reference numbers labeled in FIGS. 5 and 6), a first shroud 200 extends from a first shroud forward end 200A to a first shroud aft end 200B over the first blade stage 120C and conforms to the second blade profile 140B. The first shroud aft end 200B is forward of the flange 110. This configuration defines a first stage forward opening 120E at the body forward end 105A and a first stage aft opening 120F at the flange 110. A third blade stage 200C extends radially outwardly from the first shroud 200. A fifth blade profile 140E is defined by a third outer edge 200D of the third blade stage 200C. The curvature of the second blade profile 140B may be steeper than a curvature of the fifth blade profile 140E, or vice versa, though this is not intended on limiting the scope of the embodiment. The third blade stage 200C defines a third flow path F3 having a third flow area A3 that increases towards the body forward end 105A.

Further regarding the third embodiment of the unitary rotor 102, (with reference numbers labeled in FIG. 4) a bladeless section 145 may extend from either or both of the body forward and aft ends 105A, 105B, depending on configuration requirements. A passage 150 is defined through the unitary rotor 102, between the body forward and aft ends 105A, 105B. The passage 150 receives a drive shaft 160. At the body forward and aft ends 105A, 105B, the passage 150 defines a radially stepped-out segment 150A, 150B, to seat journal bearings 170A, 170A on the drive shaft 160. Thrust bearings 170C may be at an axial end of the drive shaft 160 (FIG. 4). The flange 110 has a radial outer surface 110A. A radial channel 110B may extend radially inwardly from the radial outer surface 110A. Thermal insulation 180 may be disposed within the radial channel 110B to reduce heat transference from between the rotors 120, 130.

As shown in FIG. 7, a second shroud 210 extends from a second shroud forward end 210A to a second shroud aft end 210B over the second blade stage 130C and conforms to the fourth blade profile 140D. The second shroud forward end 210A is aft of the flange 110. This defines a second stage forward opening 130E at the flange 110 and a second stage aft opening 130F at the body aft end 105B. A fourth blade stage 210C extends radially outwardly from the second shroud 210. A sixth blade profile 140F that may be arcuate is defined by a fourth outer edge 210D of the fourth blade stage 210C. The curvature of the sixth blade profile 140F may be steeper than a curvature of the fourth blade profile 140D, or vice versa, though this is not intended on limiting the scope of the embodiments. The fourth blade stage 210C defines a fourth flow path F4 having a fourth flow area A4 that increases towards the body aft end 105B. In addition, in one embodiment, as shown in FIG. 7, the unitary rotor 102 is symmetrical about the flange 110. However, this is not intended on limiting the scope of the embodiments.

As with the embodiment of FIG. 2, the configuration of the fourth blade stage 210C results in a compression of flows that are directed along the stage from the body aft end 105B toward the flange 110. That is, flows in the opposite direction, from the flange 110 toward the body aft end 105B will expand. The fourth blade stage 210C may be used in an ACM 33 as a compressor stage or a turbine stage, depending on the flow direction. That is, the unitary rotor in FIG. 6 is suitable for an ACM 33 requiring four stages, as a combination of compressors and turbines. In addition, the ratios of compression and expansion are the same as each other for the first and second blade stages 120C, 130C. The ratios of compression and expansion are also the same as each other for the third and fourth blade stages 200C, 210C. This configuration is not intended on limiting the scope of the embodiments. Further, the unitary rotor 101 is symmetric about the flange 110, though this is not intended on limiting the scope of the embodiments.

The embodiments combine separate rotors into a single cast, additively manufactured, or machined rotor for an ACM 33 that contains the required stages for the ACM 33 to function as intended. This results in a part-count reduction within the ACM 33, simplifying the assembly process for the ACM 33, reducing is size, and lowering is weight.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A single-shaft unitary monolithic centrifugal rotor of an air cycle machine (ACM) of an aircraft, comprising:
a body extending from a body forward end to a body aft end;
a flange intermediate the body forward and aft ends;
a first rotor, defining a first rotor stage of the compressor, extending forward from the flange by a first axial length to a first rotor end at or near the body forward end, the first rotor defining a first hub and a first blade stage extending outwardly from the first hub;
a second rotor, defining a second rotor stage of the compressor, extending aft from the flange by a second axial length to a second rotor end at or near the body aft end, and defining a second hub and a second blade stage extending outwardly from the second hub;
a passage defined through the unitary rotor, between the body forward and aft ends, that receives a drive shaft,
wherein:
a first blade profile is defined by the first hub;
a second blade profile is defined by a first outer edge of the first blade stage;
a third blade profile is defined by the second hub; and
a fourth blade profile is defined by a second outer edge of the second blade stage;
the first blade stage defines a first flow path having a first flow area that increases towards the body forward end;
the second blade stage defines a second flow path having a second flow area that increases towards the body aft end;
the first axial length is greater than the second axial length; and
a curvature of the third and fourth blade profiles is steeper than a curvature of ones of the first and second blade profiles, whereby the first blade stage is radially longer than the second blade stage and the first flow area is larger than the second flow area.

2. The unitary rotor of claim 1, wherein the unitary rotor is additively manufactured.

3. The unitary rotor of claim 1, wherein, at the body forward and aft ends, the passage defines a radially stepped-out segment, to seat a journal bearing.

4. The unitary rotor of claim 1, wherein a cavity is defined along the passage, intermediate the body forward and aft ends, the cavity being radially larger than the passage and seats a thrust bearing.

5. The unitary rotor of claim 1, wherein the flange has a radial outer surface, and a radial channel extends radially inwardly from the radial outer surface, and thermal insulation is disposed within the radial channel.

6. (canceled)

7. (canceled)

8. (canceled)

9. The unitary rotor of claim 7, further comprising:
a first shroud extending from a first shroud forward end to a first shroud aft end over the first blade stage and conforming to the second blade profile,
wherein the first shroud aft end is forward of the flange, to define a first stage forward opening at the body forward end and a first stage aft opening at the flange,
wherein a third blade stage extends radially outwardly from the first shroud; and
a fifth blade profile is defined by a third outer edge of the third blade stage.

10. The unitary rotor of claim 9, wherein the third blade stage defines a third flow path having a third flow area that increases towards the body forward end.

11. The unitary rotor of claim 10, wherein:
the first axial length is greater than the second axial length; and
a curvature of the third and fourth blade profiles is steeper than a curvature of ones of the first and second blade profiles, whereby the first blade stage is radially longer than the second blade stage and the first flow area is larger than the second flow area.

12. The unitary rotor of claim 10, further comprising:
a second shroud extending from a second shroud forward end to a second shroud aft end over the second blade stage and conforming to the fourth blade profile,
wherein the second shroud forward end is aft of the flange, to define a second stage forward opening at the flange and a second stage aft opening at the body aft end,
wherein a fourth blade stage extends radially outwardly from the second shroud; and
a sixth blade profile is defined by a fourth outer edge of the fourth blade stage.

13. The unitary rotor of claim 12, wherein the fourth blade stage defines a fourth flow path having a fourth flow area that increases towards the body aft end.

14. The unitary rotor of claim 13, wherein the unitary rotor is symmetrical about the flange.

15. An ACM of an aircraft, the ACM comprising:
a compressor having the unitary rotor of claim 3; and
a shaft extending through the passage; and
forward and aft journal bearings disposed on opposite ends of the shaft and configured so seat in ones of the radially stepped-out segment.

16. The ACM of claim 15, further comprising a thrust bearing at one end of the shaft, axially offset from the adjacent one of the forward and aft journal bearings.

17. An ACM of an aircraft, the ACM comprising:
a compressor having the unitary rotor of claim 4;
a shaft extending through the passage;
forward and aft journal bearings disposed on the unitary rotor and configured so seat in ones of the radially stepped-out segment; and
the thrust bearing disposed on the unitary rotor and configured to seat in the cavity.
